(19) United States
(12) Patent Application Publication
(10) Pub. No.: US 2003/0183187 A1
(43) Pub. Date: Oct. 2, 2003

(54) Internal combustion engine for a manually guided implement

(75) Inventors: Johannes Menzel, Stuttgart (DE); Gunter Wolf, Oppenweiler (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 10/390,230

(22) Filed: Mar. 17, 2003

(30) Foreign Application Priority Data
Mar. 30, 2002 (DE) 102 14 384.6

(51) Int. Cl. F02B 75/06

(52) U.S. Cl. 123/192.2

(57) ABSTRACT

An internal combustion engine for a manually guided implement is provided and has a cylinder, a reciprocating piston that is longitudinally displaceable in the cylinder, a rotatable crankshaft and a connecting rod for connecting the piston and the crankshaft. By means of a clutch, a tool that is to be driven can be connected to the internal combustion engine. To improve engine operation and at the same time keep a low overall weight, a rotary oscillation eliminator is provided on the engine side of the clutch and in the direction of flow of power from the internal combustion engine to the tool.

### BACKGROUND OF THE INVENTION

The present invention relates to an internal combustion engine for a manually guided implement and has a cylinder, a reciprocating piston that is longitudinally displaceable in the cylinder, a rotatable crankshaft, a connecting rod for connecting the piston with the crankshaft, and clutch for connecting the crankshaft with a tool that is to be driven.

The rotational movement of a crankshaft of an internal combustion engine is irregular due to the principle of the discontinuous combustion and the thereby resulting irregular movement of the piston, connecting rod and other components. The moved components form, together with a driven tool, a system which is capable of vibrating, which tends to cause resonance. This effect is particularly pronounced with small and lightweight internal combustion engines of an implement that have only a single cylinder, where the irregularity of the rotational movement is particularly pronounced. Since a manually guided implement, such as a chain saw, a brush cutter, or the like, should be as lightweight as possible for easy manipulation and operation, the mass forces of uniformly moved parts that occur are relatively low in comparison to the irregular drive moment. The mass forces of the uniformly moved parts can therefore contribute little to the dampening of the fluctuations of torque.

Rotary oscillation dampeners in a clutch between a drive motor and a driven tool are known for dampening vibrations stimulated in particular during the coupling process. To smooth the torque peaks of the rotating system comprised of the internal combustion engine and the driven tool, the arrangement of flywheels is known. These known measures lead to an undesirable increase in the weight of the implement, thereby adversely affecting the ability to handle and operate the implement.

It is therefore an object of the present invention to provide an internal combustion engine of a manually guided implement with improved operating characteristics.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of a manually guided implement having an internal combustion engine with a saw chain;

FIG. 2 is a perspective exploded view of a crankshaft having a swingingly suspended eliminator;

FIG. 3 is a variation of the arrangement of FIG. 2, with a swinging eliminator that is encased in the crank web;

FIG. 4 is an exploded view of a crank drive having a cylindrical elimination mass that is guided along a curved roller path in the crank web of the crankshaft;

FIG. 5 is a variation of the arrangement of FIG. 4 with a total of two elimination masses;

FIG. 6 is an exploded view of a crankshaft having a combined swinging elimination mass that is also mounted in a curved roller path; and

FIG. 7 is a further variation of a rotary oscillation eliminator having a cylindrical elimination body on a fan wheel of the internal combustion engine.

### SUMMARY OF THE INVENTION

The internal combustion engine of the present invention is characterized primarily by a rotary oscillation eliminator that is provided on the engine side of the clutch and in the direction of flow of power from the internal combustion engine to the tool.

The special characteristic of a rotary oscillation eliminator is that in addition to the improved rotary oscillation system, a further rotary oscillation system is provided that with a suitable coordination operates in an opposite direction. The mass forces that result are at least largely eliminated, as a consequence of which the resulting rotary oscillation amplitudes are at least largely also eliminated. In comparison to a dampening system, no energy is dissipated, as a result of which neither thermal nor in particular wear problems arise. A rotary oscillation eliminator itself can be easily embodied in comparison to a mass flywheel.

Oscillation eliminators are known, and are utilized in particular for motor vehicle engines in the driveline near the clutch. However, such arrangements are not suitable for a manually guided implement since, as an additional component, they increase the weight of the system.

As a consequence of an arrangement pursuant to the present invention, the rotary oscillation eliminator is disposed on the engine side of the clutch. At this location, the elimination effect is also provided when the tool is not coupled. Such clutches are advantageously embodied as centrifugal clutches. In the lower speed range of the internal combustion engine, the tool does not operate and is not available as a dampening mass for the internal combustion engine. However, at the same time, especially with a one-cylinder engine, at appropriately low speed the rotary oscillation stimulation is particularly pronounced. This can be at least partially compensated for pursuant to the present invention with a relatively lightweight rotary oscillation eliminator. Also in the coupled state, the rotary oscillation eliminator contributes to the reduction of the rotary oscillation level.

Pursuant to an advantageous further development of the invention, the rotary oscillation eliminator is provided in the region of a mass balancing means for compensating for imbalances. For example, such a mass balancing means is provided on a crank web of the crankshaft to compensate for the imbalance of the crankpins and connecting rod. Another imbalance results due to the arrangement of a control magnet for an ignition means, especially on a fan wheel of a cooling air blower. By arranging the rotary oscillation eliminator of the corresponding mass balancing means, the mass of the rotary oscillation eliminator can have a dual function as also the mass balancing means. The mass balancing means that is present due to the nature of the system can be reduced in mass by a corresponding amount. The increase in mass of the overall system due to the arrangement of the rotary oscillation eliminator is low. Consequently, overall the possibility is provided for making the internal combustion engine lightweight while at the same time having a low rotary oscillation level.

The rotary oscillation eliminator is advantageously embodied as a speed adaptive eliminator having an elimination mass and an inertial-force-controlled centering of the elimination mass. By suitable coordination of the elimination mass and the inertial-force-controlled centering, an automatic adaptation of the eliminator to the speed can be achieved. The elimination effect thereby extends over a wide range of excitation or stimulation frequencies. It is thus possible to achieve a high effectiveness not only in the range of the uncoupled idling, but also in the range of high speeds with the clutch and tool engaged.

The elimination mass is advantageously embodied as a pendulum that is swingingly mounted about a point of rotation. The pendulum thus forms a rotary oscillator; if the point of rotation is eccentrically arranged relative to the axis of rotation of the crankshaft, the resulting centrifugal forces cause a centering due to the mass forces. Embodying the pendulum with a mounting about a point of rotation can be easily structurally provided, whereby the frictional forces at the appropriate axis of rotation are relatively low. There is thereby ensured a precise orientation of the elimination mass. Pursuant to a further development of the invention, the elimination mass is guided on a curved roller path, whereby the elimination mass is in particular embodied in a manner of a roller and can roll off on the roller path. With this variation, the radius of curvature of the roller path can have any desired accommodating course, as a result of which the oscillation characteristic of the elimination mass can be set to be linear or non-linear. With a rolling-off embodiment, the frictional forces are low in comparison to a sliding mounting. The oscillation characteristic of the elimination mass can be set such that in the range of the operating amplitudes, the elimination mass can freely settle down. For unexpectedly high amplitudes under exceptional operating conditions, it can be expedient to provide an abutment dampener for the elimination mass.

Due to the arrangement of respectively at least one rotary oscillation eliminator on the crankshaft on both sides of the connecting rod, it is furthermore possible to avoid or compensate for dynamic imbalances that occur.

Further specific features of the present invention will be described in detail subsequently.

### DESCRIPTION OF PREFERRED EMBODIMENTS

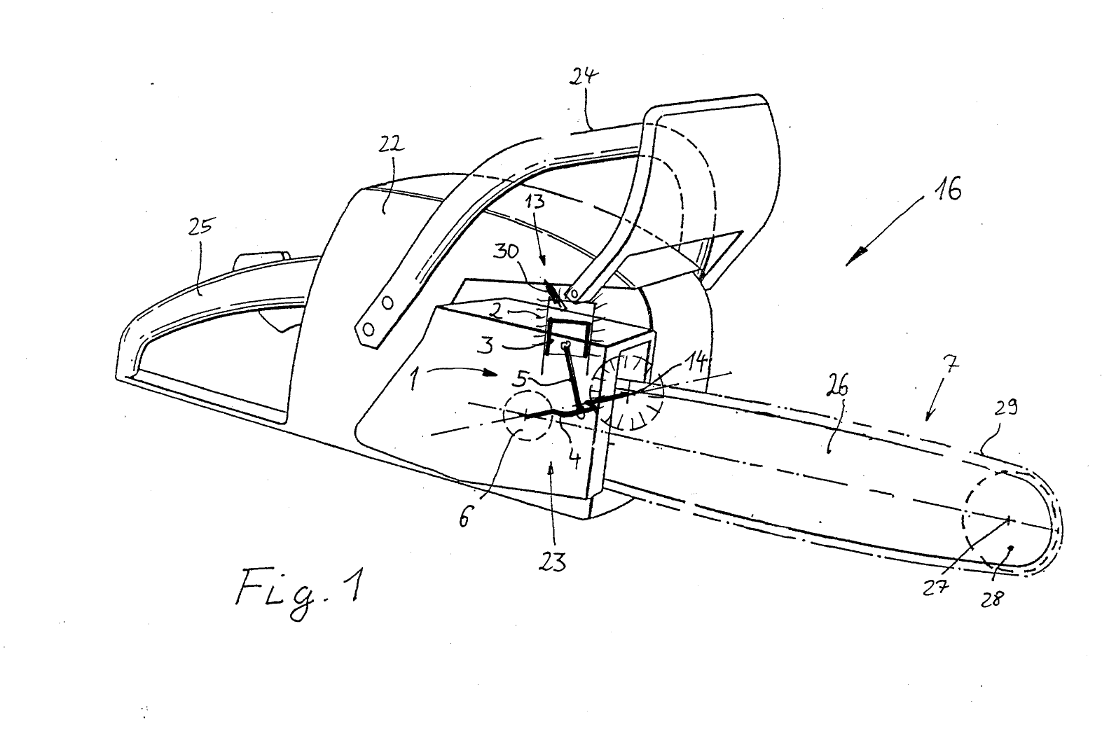

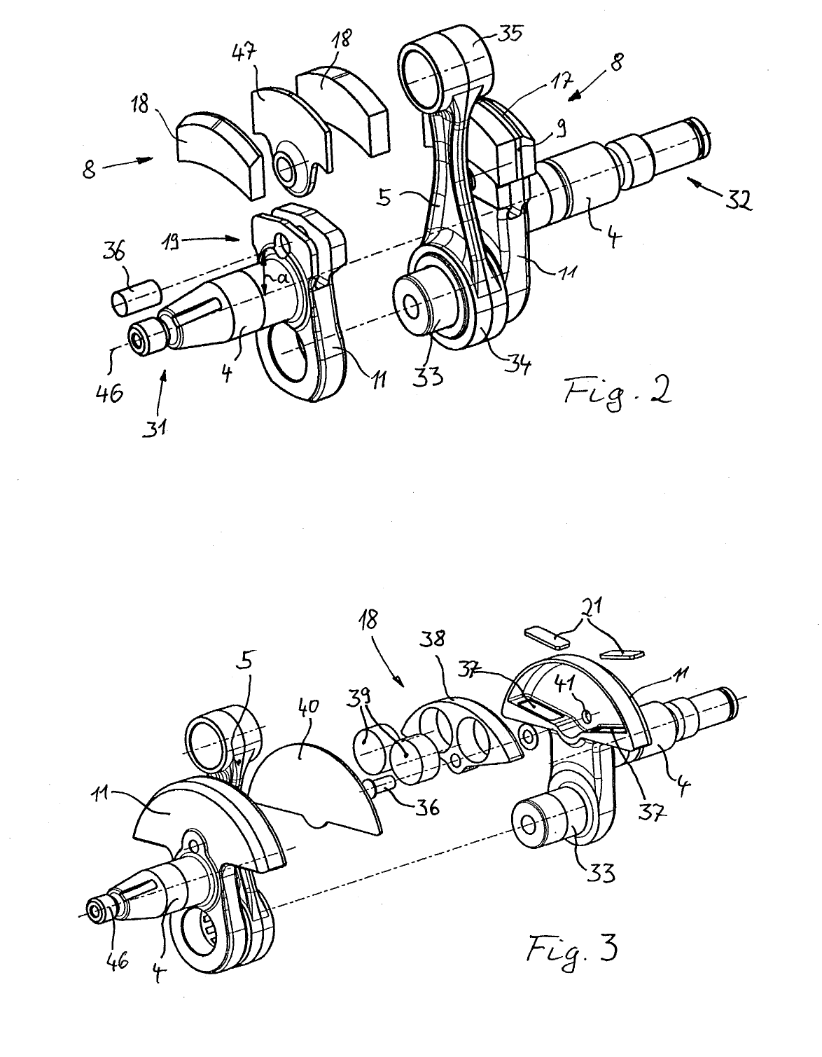

Referring now to the drawings in detail, FIG. 1, in a schematic perspective illustration, shows a manually-guided implement, here by way of example a chain saw 16, having an internal combustion engine 1 that is embodied as a two-cycle engine and serves for driving a saw chain 29. Other manually-guided implements, such as brush cutters or the like, could also be provided. The internal combustion engine 1 can be not only a two-cycle engine but also a four-cycle engine, and is provided in the illustrated embodiment with a single cylinder 2 in which is longitudinally displaceably guided a piston 3 in a reciprocating manner. By means of a connecting rod 5, the piston 3 is connected with an indicated crankshaft 4 for producing a rotational movement about a crankshaft axis 46 (see FIGS. 2-4). Part of an ignition means 13 is a spark plug 30 that is disposed in the cylinder 2. Fixed in position on one side of the crankshaft 4 is a coupling or clutch 6 by means of which, above a prescribed rotational speed of the crankshaft 4, the tool 7, which is in the form of the saw chain 29, is driven. Disposed on that side of the internal combustion engine 1 opposite the clutch 6 is an indicated fan wheel 14 for cooling the internal combustion engine, especially in the region of the cylinder 2; the fan wheel 14 is driven by the crankshaft 4.

The internal combustion engine 1, with its clutch 6 and its fan wheel 14, is disposed in an implement housing 22, whereby the clutch 6 is covered by a clutch cover 23. To guide the chain saw 16, the implement housing 22 is provided with a front and a rear handle 24 and 25.

The saw chain 29 is guided in a circulating manner along the edges of a guide bar 26, whereby for reversing the direction of the saw chain 29, there is provided at that end of the guide bar 26 that is remote from the clutch 6 a guide wheel 28 that is rotatable about an axis 27. In the region of that end of the guide bar 26 that is near the engine the saw chain 29 is looped about the clutch 6.

The perspective, exploded view of FIG. 2 shows details of the crankshaft 4 of the internal combustion engine 1 of FIG. 1. The crankshaft 4 has two sections, and is provided with a respective crank web 11 on both sides of the connecting rod 5. In the region of the crank webs 11, the two sections of the crankshaft 4 are connected by means of a crankpin 33, whereby the connecting rod 5 is mounted on the crankpin 33 via a lower bearing 34. The clutch 6 is fixedly connected to one end 31 of the crankshaft 4, and the fan wheel 14 is fixedly connected to the opposite end 32 of the crankshaft 4 (see FIG. 1).

The crank webs 11 are each provided with a mass balancing means 9 for the masses of the crankpin 33 and the connecting rod 5. In the illustrated embodiment, the mass balancing means 9 is embodied in the form of a rotary oscillation eliminator 8 that is integrated in the crank web 11; the rotary oscillation eliminator 8 is provided with elimination masses 18. In each case, two elimination masses 18 are secured to both sides of a carrier plate 47, and are suspended on the crank web 11 in a swinging manner via a journal or pivot means 36. The point of rotation 19 formed by the pivot means 36 is radially spaced by the distance a relative to the axis 46 of the crankshaft. The centrifugal forces that become active during rotation of the crankshaft 4 consequently lead to an inertial-force-controlled centering of the swingingly suspended elimination masses 18. In this embodiment, the rotary oscillation eliminator 18 acts as a speed adaptive or self-adjusting eliminator 17. It can also be expedient to provide elastic spring elements or the like for the centering of the elimination masses 18.

FIG. 3 shows a variation of the arrangement of FIG. 2 with a speed adaptive eliminator 17, whereby the crank webs 11 of the crankshaft 4 are hollow. A carrier member 38, which has the approximate shape of a circular sector, is provided with bores for receiving mass bodies 39, thereby on the whole forming an elimination mass 18. By means of the journal or pivot means 36, the elimination mass 18 is swingingly mounted in a mounting opening 41 on the crank web 11. The hollow space in the crank web 11 for receiving the elimination mass 18 is covered by a cover plate 40, whereby in the region of the cover plate and of the mounting opening 41, motor oil can be supplied to the eliminator 17 for lubrication via planned lack of seals. Provided on the inner side of the crank web 11 are receiving spaces 37 for abutment dampeners 21 against which the carrier member 38 can engage in a dampened manner during high swinging amplitudes. With regard to the remaining features and reference numerals, the illustrated embodiment corresponds to the arrangement of FIG. 2.

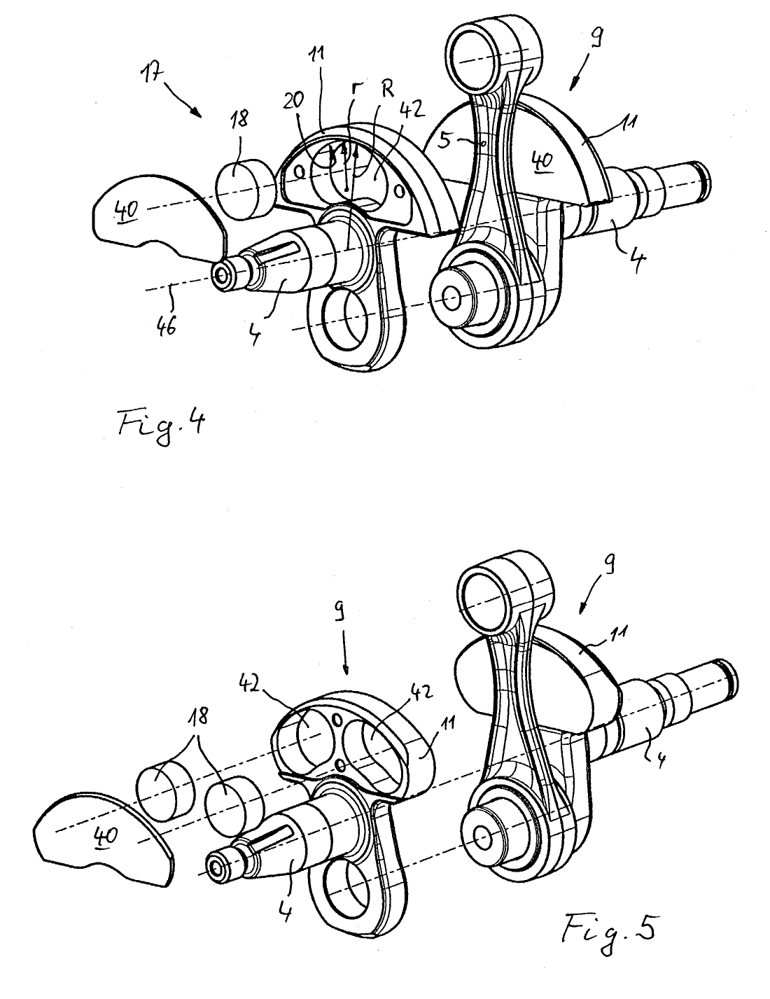

FIG. 4 shows a variation of a speed adaptive eliminator 17 in the crank webs 11 of a crankshaft 4, whereby the crank webs are provided with curved milled-out areas 42. Provided on the radially outer boundary of the milled-out area 42 is a curved roller path 20 for a cylindrical elimination mass 18, which can roll on the roller path 20. To form a centering of the elimination mass 18 that is inertial-force-controlled, the roller path 20 has a radius of curvature r that is less than its radial spacing R relative to the axis 46 of the crankshaft. In the illustrated embodiment, the radius of curvature r of the roller path 20 is constant, although to form any desired deflection characteristic of the elimination mass 18, it can have any desired, suitable, angle dependent course. The elimination mass 18 is disposed loosely into the milled-out area 42 and is prevented from falling out on both sides by cover plates 40.

In the variation of the arrangement of FIG. 4 shown in FIG. 5, each crank web 11 is provided with two milled-out areas 42, each for a respective elimination mass 18. The remaining features and reference numerals correspond with the arrangement of FIG. 4.

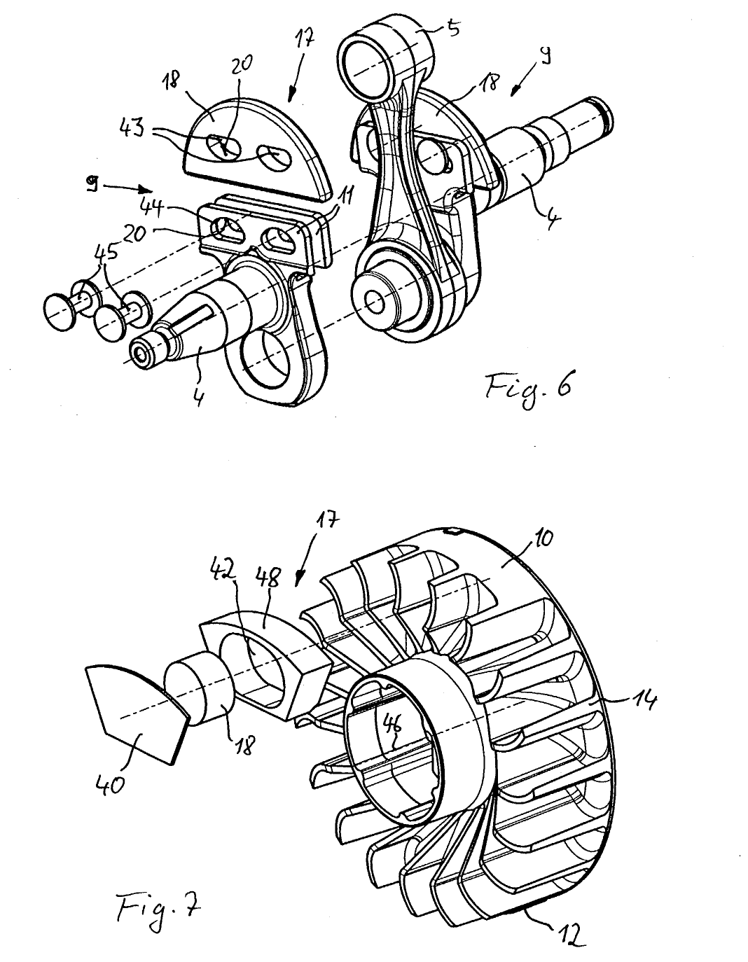

FIG. 6 shows a further variation of a crankshaft arrangement having a speed adaptive eliminator 17, according to which the elimination mass 18 is in the form of a semicircular disc having two similarly approximately semicircular recesses 43. The crank web 11 has a forked shape for receiving the elimination mass 18, and is also provided with approximately semicircular shaped recesses 44. The recesses 43 and 44 respectively form curved roller paths 20 and are movable relative to one another via interposed, rivet-shaped roller bodies 45. This results in a combination of a swinging movement of the elimination mass 18 in conformity with the embodiments of FIGS. 2 and 3 with a rolling-off movement in conformity with the embodiments of FIGS. 4 and 5.

In the embodiments of FIGS. 2 to 6, a respective rotary oscillation eliminator 8, in the form of the illustrated speed adaptive eliminator 17, is respectively disposed on both sides of the connecting rod 5. In this connection, the elimination masses 18 simultaneously also form the mass balancing means 9 for imbalances, which result, for example, from the mass forces of the crankpins 33 and the connecting rod 5. As a consequence of this dual function, no additional mass is added to the overall internal combustion engine 1 via the elimination masses 18.

FIG. 7 additionally shows an embodiment of a speed adaptive eliminator 17 that is disposed in the fan wheel 14 of FIG. 1. Disposed on the peripheral side of the fan wheel 14 is a control magnet 12 for controlling the ignition point of time of the ignition means 13 and the spark plug 30 (FIG. 1). Oppositely disposed relative to the axis 46 of the crankshaft is a further mass balancing means 10 for the control magnets 12. Disposed within the mass balancing means 10 is a receiving body 48 which is provided with a milled-out area 42 for receiving a cylindrical elimination mass 18 in conformity with the embodiments of FIG. 4. A cover plate 40 is provided to secure the elimination mass 18.

In the illustrated embodiments, the rotary oscillation eliminators 8 are disposed in the region of the crankshaft 4 or the fan wheel 14, and hence, pursuant to FIG. 1, on the engine side of the clutch 6 in relation to the direction of flow of force from the internal combustion engine 1 to the tool 7. Furthermore, the arrangement of a rotary oscillation eliminator can also be expedient at other suitable locations of the internal combustion engine 1, especially on that portion of the clutch 6 that is fixed in position on the engine side.

The specification incorporates by reference the disclosure of German priority document 102 14 384.6 filed Mar. 30, 2002.

The present invention is, of course, in no way restricted to the specific disclosure of the specification and drawings, but also encompasses any modifications within the scope of the appended claims.

We claim:

1. An internal combustion engine for a manually guided implement having a cylinder, a reciprocating piston that is longitudinally displaceable in said cylinder, a rotatable crankshaft, a connecting rod for connecting said piston with said crankshaft, and a clutch for connecting said crankshaft with a tool that is to be driven, said internal combustion engine further comprising:
a rotary oscillation eliminator that is provided on an engine side of said clutch and in a direction of flow of power from said internal combustion engine to said tool.

2. An internal combustion engine according to claim 1, wherein a mass balancing means is provided for compensating for imbalances, and wherein said rotary oscillation eliminator is disposed in the vicinity of said mass balancing means.

3. An internal combustion engine according to claim 2, wherein said crankshaft is provided with a crank web on which said mass balancing means is disposed, and wherein said rotary oscillation eliminator is disposed in the vicinity of said crank web.

4. An internal combustion engine according to claim 3, wherein said rotary oscillation eliminator is integrated into said crank web.

5. An internal combustion engine according to claim 2, wherein a control magnet for an ignition means of said internal combustion engine is connected with said crankshaft, wherein a further mass balancing means for said control magnet is connected with said crankshaft and wherein said rotary oscillation eliminator 8s provided in a vicinity of said further mass balancing means.

6. An internal combustion engine according to claim 1, wherein a cooling air blower having a fan wheel is provided for said internal combustion engine, and wherein said rotary oscillation eliminator 8 is disposed on said fan wheel.

7. An internal combustion engine according to claim 6, wherein said rotary oscillation eliminator is integrated into said fan wheel.

8. An internal combustion engine according to claim 1, wherein said rotary oscillation eliminator is a speed adaptive eliminator having an elimination mass and an inertial-force-controlled centering of said elimination mass.

9. An internal combustion engine according to claim 8, wherein said elimination mass is swingingly mounted about a point of rotation.

10. An internal combustion engine according to claim 8, wherein said elimination mass is guided along a curved roller path.

11. An internal combustion engine according to claim 10, wherein said elimination mass is guided on said roller path in a rolling contact manner.

12. An internal combustion engine according to claim 11, wherein said elimination mass is embodied as a roller.

13. An internal combustion engine according to claim 8, wherein an abutment dampener is provided for said elimination mass.

14. An internal combustion engine according to claim 1, wherein when viewed in a longitudinal direction of said crankshaft, a respective rotary oscillation eliminator is provided on both sides of said connecting rod.
